(19) United States
(12) Patent Application Publication
(10) Pub. No.: US 2007/0112091 A1
(43) Pub. Date: May 17, 2007

(54) Low density rocket motor insulation

(76) Inventors: Jun-Ling Fan, Taipei City (TW); Shr-Hau Tsai, Jinhu Township (TW); Fu-Hua Tu, Bade City (TW); Yao-Tsai Tu, Sindian City (TW)

Correspondence Address: RABIN & Berdo, PC, 1101 14TH STREET, NW, SUITE 500, WASHINGTON, DC, 20005, US

(21) Appl. No.: 11/271,979

(22) Filed: Nov. 14, 2005

(51) Int. Cl. F02K 9/34

(52) U.S. Cl. 523/138

(57) ABSTRACT

A composition of elastomeric insulation is provided. This composition is suitable to be used as a non-asbestos insulation in a solid rocket motor. In this embodiment, an EPDM rubber, a polyaramide fiber, a liquid EPDM rubber and an aluminum hydroxide are used to substitute the hazardous asbestos in traditional insulation materials to prevent environmental contamination. With careful formulation control, density of the composition based on this embodiment can be tailored to lower than 1.0 gm/cm³. Thus enable the insulation to be especially applicable in the areas of lower ablation rate in a solid rocket motor to reduce tare weight of the rocket motor. Moreover, since no chlorinated organic fire retardant compound is used therein, the additional advantage of low smoke density and low smoke toxicity is exhibited.

### BACKGROUND

1. Field of the Invention

This invention relates to a composition of rubber compound, and in particular to a composition of elastomeric insulation, made of ethylene propylene diene monomer (EPDM) rubber based low density composition, suitable to be used as insulation in a solid propellant rocket motor.

2. Description of the Prior Art

Generally, the propellant of a solid rocket motor comprises high energy material and oxidizers, which produce a huge amount of exhausted gas and heat after being ignited by an ignition system. The heat produced will accumulate in the limited space in the motor case leading to a temperature as high as 2400° C. to 3700° C. therein. The burning propellant produces high speed and high temperature gas particles that may seriously damage the motor case. Therefore, it is necessary to have an insulating system in the motor case to protect it from ablation by the burning particles.

Traditional insulations are comprised of asbestos, aluminum hydroxide (Al (OH₃), antimony trioxide (Sb₂O₃), silicon dioxide (SiO₂), and organic fire retardant materials used as fillers in rubber composition. The rubber based insulation is tailored and applied to the inner wall of a rocket motor case with a proper method to prevent the case from damage while the rocket is fired.

As disclosed in U.S. Pat. No. 3,347,047, the rocket motor insulation is made by adding asbestos to the rubber composition. This material is suitable for the inflatable mandrel technique in rocket motor fabrication. In this process, 3 phr (parts per hundred parts of rubber by weight) to 200 phr asbestos are added to the rubber composition. A product named V 44 from the Aerojet Company in the U.S., is made by this method based on NBR (Acrylonitrile Butadiene Rubber) and asbestos fiber. It has a density of 1.28 gram per cubic centimeter (gm/cm³) and meets the ablative resistance requirements for rocket motor insulation. V 44 is also widely used in various kinds of missiles, such as the Patriot of the U.S. and the Gabriel of the Israel. However, the asbestos fiber used in the insulation formulation may inevitably flutter in the air during the manufacturing of the insulation or after the missile is launched. This certainly endangers the health of the related workers and the peripheral environment.

According to U.S. Pat. No. 4,501,841 (issued in 1985) and U.S. Pat. No. 4,878,431 (issued in 1989), polyaramide fiber (trade name: Kevlar) and inorganic fillers were used instead of asbestos fiber in the insulation formations. However, the density of the insulations ranges from 1.4 gm/cm³ to 1.5 gm/cm³. Such a high density may increase the total weight of the rocket, and therefore, reduce the firing range.

As disclosed in U.S. Pat. No. 5,821,284 (issued in 1998), synergistic effect was observed by using ammonium sulphate ((NH₄)₂SO₄) and antimony trioxide (Sb₂O₃) in an ethylene propylene diene monomer (EPDM) rubber and polyaramide fiber based insulation formulation. The ablation resistance of the insulation is highly improved from such a synergistic effect. In addition, density of the insulation is lowered to 1.18 gm/cm³. However, Sb₂O₃ in the insulation give off toxic gases during the ablation process that endanger the environment.

As disclosed in U.S. Pat. No. 4,878,431 (issued in 1989), a chlorinated compound (Dechlorain plus 515) is used as ablation resistance filler in an insulation formulation. Whereas, as disclosed in the U.S. Pat. No. 4,571,436 (issued in 1986), a chlorosulfonated polyethylene (Hypalon) is used as a rubber binder in an insulation formulation. Insulation made thereof is decomposed due to high temperature while the rocket motor is fired. It may release corrosive hydrogen chloride gas, which enhances smoke density produced while the propellant in the rocket is burned.

As disclosed in U.S. Pat. No. 5,023,006 (issued in 1991), a insulation is prepared by adding 2-chlorobutadene and 1,3-elastomer to the EPDM rubber information. This rubber system is cured by using 40% a,a′-bisterbutylperoxide and diisopropylbezene. A 0.25 mm short-staple polyaramide fiber was used. No any physical property and density of this insulation were described in this application.

As disclosed in U.S. Pat. No. 5,498,649 (issued in 1996), insulation is made by a polyamide polymer and a maleic anhydride modified EPDM rubber. It states that the density of the insulation may be reduced, but there is no further data for its ablation resistance property. Besides, the insulation provided here is a thermal plastic material that is very different from the commonly known thermosetting system for the general insulation s.

U.S. Pat. No. 6,566,420 (issued in 2003) and U.S. Pat. No. 6,606,852 (issued in 2003) stated that peroxides are used as curing agent in EPDM based insulations. In these embodiments no Kevlar fiber is described in the insulation formation. Moreover, insulation densities described in these embodiments are both higher than 1.0 gm/cm³.

Thus it can be seen, in the related arts of the insulation, the densities of the rubber material are all greater than 1.0 gm/cm³. So, when it is applied to the rocket motor, it does not help effectively in reducing tare weight of the rocket motor. The tare weight of a rocket motor is the total weight of the rocket motor without including that of the propellant and the thrust nozzle.

### SUMMARY

The object of the present invention is to provide an ethylene propylene diene monomer (EPDM) rubber based low density insulation composition, which can be used in a solid rocket motor and may prevail over the disadvantages of the prior arts.

Another object of this invention is to provide an EPDM rubber based low density composition that is used as insulation with superior ablation resistance property. When this insulation is applied to the area that is less aggressively ablated by the high speed and high temperature burning gas particles in a solid rocket motor, such as the steady-state burning area, it can effectively reduce the tare weight of the rocket motor.

The EPDM rubber based low density composition of this invention completely renounces the use of asbestos fiber as filler, which is carcinogenic.

According to this invention, an EPDM rubber based low density composition, which is used as insulation for a solid propellant rocket motor, is formed primarily by an EPDM rubber and a polyaramide fiber. It further includes inorganic fillers such as aluminum hydroxide and/or silicon oxide as ablative resistant filler. In that, organic polyaramide fiber is used to substitute the asbestos fiber that is used in traditional insulation for solid propellant rocket motor. The polyaramide fiber filled insulation may completely carbonize and turned into solid char when it is burned in a rocket motor.

In addition, liquid EPDM rubber is used in the composition to adjust softness of the green (uncured) insulation. In this way, hand lay up method or inflatable mandrel technique can be used to apply the insulation to the inner wall of the rocket motor case. And therefore, the use of exquisite and costly machine to prepare the uncured insulation can be avoided compared to those generally used for commercially available insulations formulated with high content Kevlar fiber (30 phr to 120 phr). These commercially available products usually have much higher toughness of the uncured insulations than that of this invention.

Furthermore, the cured insulation has low density, low thermal conductivity, appropriate hardness and excellent ablation resistance properties. When this insulation is applied at the less aggressively ablated region of a rocket motor, tare weight of the solid rocket motor can be effectively reduced.

Moreover, when the EPDM rubber based low density composition of this invention is applied, through an appropriate method, and cured at the inner wall of the solid rocket motor case, it turns into a hard char during ablation, that effectively protect the motor case from perforation and damage caused by high speed and high temperature burning gas particles. As a result, the rocket motor case is secured during its flight.

### DETAILED DESCRIPTION

Accordingly a thermalset rubber material is used for the present insulation system. Polyaramid fiber is used as a substitute for asbestos that is used in traditional insulations. Aluminum hydroxide and silicon oxide are used as ablation resistance fillers for the present insulation system. An ethylene propylene diene monomer (EPDM) rubber is used in this composition as a binding agent for the fillers. EPDM rubber is of low density, good aging resistance and good flexibility under low temperature. It also gives better ablation resistance property. Further, a liquid EPDM rubber is used to adjust the flexibility of the uncured insulation to facilitate its application processes afterwards.

The insulation of this invention has the advantages of a density lower than 1.0 gm/cm³ tested according to ASTM D 792 (American Society for Testing and Materials), an appropriate Shore A hardness of 74±7 according to ASTM D 2240, a low thermal conductivity coefficient of ≦0.245 Kcal/m.h.° C. according to ASTM C 581, and a good ablation resistance property of ≦0.122 mm/sec according to ASTM E 285. The insulation of this invention is not only of good aging resistance but is also of good flexibility at temperature as low as −50° C. Additionally, the exhausted gas from launch of the rocket is of low toxicity and low smoke density. Thus it is very applicable to be used as the insulation in the solid rocket motor. Furthermore, because of its low density, the insulation is especially suitable to be applied to the area in a solid rocket motor that is less aggressively ablated by the high temperature and high speed gas particles produced during the combustion of the propellant. As a result, the tare weight of the rocket motor is reduced and the speed and the firing range of the rocket can be increased.

According to this invention, an EPDM rubber is used as a binder resin for the insulation and sulfur is used as a curing agent to cure the rubber system at lower than 150° C., which is the lowest depleting temperature for peroxide type curing agents. In addition, sulfur used in this invention is colloidal sulfur. The amount of sulfur used is 0.01 phr to 5 phr based on the weight of EPDM rubber in the formulation and is preferably from 0.5 phr to 2.5 phr. The curing accelerator used in this invention is N-tert-butyl-2-benzothiazole sulfonamide and/or 4,4′-dithio dimorpholine. The amount of the N-tert-butyl-2-benzothiazole sulfonamide is 0.01 phr to 3 phr based on the weight of EDPM rubber and is preferably from 0.05 phr to 2 phr. The amount of the 4,4′-dithio dimorpholine is 0.01 phr to 3 phr based on the weight of EDPM rubber and is preferably from 0.05 phr to 2 phr.

Preferably, polyaramid fiber used in the present invention is in pulp form that has a length to diameter ratio being in the range about 500.

The fiber of polyaramid pulp used in this invention is 0.5 mm to 4 mm in length- with a preferred length of 1 mm to 3 mm long. It is added in the insulation formulation in a range from 5 phr to 20 phr based on the weight of EPDM rubber and more preferably from 10 phr to 30 phr. The specifications of polyaramide fiber are listed in Table 1.

TABLE 1
Physical properties of polyaramide fiber

| | |
|---|---|
| tensile strength (kgf/cm²) | 30,000˜40,000 |
| tensile modulus (kgf/cm²) | 7.6 × 10⁸˜1 × 10¹⁰ |
| elongation (%) | 3˜5 |
| density (Shore A, gm/cm³) | 1.4˜1.5 |
| fiber diameter (μm) | 10˜14 |
| thermal decomposition temperature (° C.) | 400˜600 |
| thermal expansion coefficient (1/° C.) | −2 × 10⁻⁶ |

In addition, a liquid EPDM rubber is used in the insulation composition of this invention to act as a plasticizer. It improves flexibility of the uncured insulation. In doing so, it helps complete the mixing of various kinds of solid fillers and Kevlar fibber in the solid EPDM rubber matrix. A typical level of liquid EPDM rubber added in the insulation composition of this invention is from 0 phr to 50 phr and is preferably from 20 phr to 45 phr. The liquid EPDM rubber is of the same chemical structure as that of the solid EPDM rubber but different in molecular weight. They are completely compatible therewith. These two kinds of rubbers may co-cure simultaneously when the insulation is heated to cure. Insulation prepared in this way may prevent migration from happening if any liquid plasticizer is used in an insulation formulation. The net effect is to ensure storage security of the solid rocket motor during its service period. Liquid rubber used in the insulation of this invention also exhibit tacky effect that promotes adhesion between layers of the uncured insulation. This effect can even be further improved by using a tackifier in the compounding recipe. The tackifier used in the present invention is synthetic polyterpene resin. The tackifier used in the present invention is in a range from 1 phr to 10 phr of EPDM rubber and is more preferably from 4 phr to 8 phr.

The silicon oxide (SiO₂) used in this invention is prepared by the wet method and was treated with a coupling agent before it was used in compounding. Treating SiO₂ with a coupling agent may improve bonding force between the SiO₂ and the EPDM rubber, and hence, improve physical properties of the insulation. Herein, the coupling agent used may be a mercapto-functional silane with sulfhydryl end group. An example of such compound is gamma-Mercaptopropyltrimethoxysilane (SHCH₂CH₂CH₂Si(OCH₃)₃) named as A-189 by Union Carbide Co,. The coupling agent used in this invention is about of 1% (wt/wt) of the total SiO₂ used in this composition.

### EXAMPLE 1

EPDM rubber (407.0 gram, 70 phr) is masticated in a one liter capacity Banbury mixer for 20 seconds. Liquid EPDM rubber (174.0 gram, 30 phr) and polyaramide fiber (87.7 gram, 12.5 phr) are then incorporated and proceed for another 40 seconds. By processing in this way, the surface of the polyaramid fiber may be thoroughly coated with the liquid EPDM rubber and it helps the fiber to have a better dispersion in the solid EPDM rubber. Next, stearic acid (7.0 gram, 1 phr) is added in the mixing process for another 20 seconds. And then, silicon oxide (35.1 gram, 5 phr) and aluminum hydroxide (70.2 gram 10 phr) are added in the compounding process for another 30 seconds. Substituted diphenylamine (7.4 gram, 1 phr) anti-oxidant and synthetic polyterpene resin (35.1 gram, 7 phr) tackifier are followed in the mixing process for another 30 seconds. And finally, zinc oxide (35.1, 5 phr) is added and the compound is blended for another 20 seconds. The blended rubber stock is then brought to a two-roll mixer to add sulfur (14.1 gram, 2 phr) and 4,4-disulfide dimorpholine (7.0 gram, 1 phr) curing accelerator for 2 minutes. Thus a rubber based low density composition which can be used as rocket motor insulation is obtained.

### EXAMPLE 2 TO EXAMPLE 5

The operational procedure of Example 1 is listed in Table 2. Formulation ingredients 110 are changed according to Example 2 through Example 5 as indicated in Table 3. Low density insulation compositions are obtained by using the same mixing procedure in Table 2.

TABLE 2
Insulation Preparation Procedure

| Procedure | Mixing time (sec) |
|---|---|
| EPDM rubber mastication | 20 |
| polyaramide fiber addition | 40 |
| stearic acid addition | 20 |
| inorganic filler addition | 30 |
| organic filler addition | 30 |
| tackifier/antioxidant addition | 30 |
| Sulfur and curing accelerator addition | 120 |

TABLE 3
Test Samples Formulation Comparison

Examples

| Compounds (phr) | 2 | 3 | 4 | 5 |
|---|---|---|---|---|
| EPDM rubber^{a} | 70 | 70 | 70 | 70 |
| liquid EPDM rubber^{b} | 30 | 30 | 30 | 30 |
| zinc oxide | 5 | 5 | 5 | 5 |
| stearic acid | 1 | 1 | 1 | 1 |
| antioxidant^{c} | 1 | 1 | 1 | 1 |
| polyaramide fiber^{d} | 12.5 | 5 | 12.5 | 12.5 |
| aluminum hydroxide | 0 | 10 | 20 | 20 |
| silicon oxide^{e} | 5 | 7 | 20 | 10 |
| tackifier^{f} | 7 | 7 | 7 | 7 |
| coupling agent^{g} | 0.5 | 0.5 | 0.5 | 0.5 |
| halogen fire retardant^{h} | — | — | — | 35 |
| antimony trioxide (Sb₂O₃) | — | — | — | 10 |

trade names of the compounds:
^{a}Sumitomo 505A;
^{b}Trilene 65;
^{c}Naugard 445;
^{d}Kevlar pulp;
^{e}Hi-Sil 233T;
^{f}Wingtack95;
^{g}A-189;
^{h}Dechloran Plas 25.

Physical Properties

The products obtained from Example 1 through Example 5 are calendered into thin sheet from a calender machine and collected into rolls. Polyethylene film was used as backing separator between each layer of the insulation sheet. The uncured insulation sheet is then cut and processed through a suitable method, such as inflatable mandrel technique, to prepare insulation of a rocket motor. The insulation is then cured by applying pressure and temperature to the system.

Biaxial nature of the insulation sheet is formed due to the alignment of the polyaramide fiber along with the direction of the roller movement during calendering. Therefore, physical properties of the same insulation sheet are totally different depending on whether the apply force to the sample is parallel or perpendicular to the distribution of the polyaramide fiber. The tested results are shown in Table 4.

TABLE 4
Test results for physical properties

| | | Examples | | | | |
|---|---|---|---|---|---|---|
| Physical properties | | 1 | 2 | 3 | 4 | 5 |
| uncured insulation | | | | | | |
| tensile strength | parallel | 11.38 | 10.11 | 8.24 | 12.75 | 13.25 |
| (kgf/cm²) | vertical | 2.42 | 2.21 | 3.52 | 4.12 | 4.23 |
| elongation (%) | parallel | 12.84 | 13.42 | 20.43 | 12.67 | 12.78 |
| | vertical | 64.43 | 78.53 | 74.22 | 67.52 | 64.37 |
| cured insulation | | curing condition: 130° C./2 hr/30 kgf/cm² | | | | |
| tensile strength | parallel | 105.84 | 101.21 | 97.24 | 137.09 | 142.37 |
| (kgf/cm²) | vertical | 50.54 | 47.42 | 55.63 | 63.18 | 67.24 |
| elongation (%) | parallel | 28.42 | 34.52 | 52.37 | 31.17 | 46.54 |
| | vertical | 191.70 | 210.40 | 198.33 | 162.43 | 172.23 |

| | | | | | |
|---|---|---|---|---|---|
| hardness (Shore A) | 74 | 67 | 71 | 75 | 82 |
| density (gm/cm³) | 0.99 | 0.92 | 0.98 | 1.08 | 1.19 |
| thermal conductivity (Kcal/mh° C.) | 0.229 | 0.231 | 0.237 | 0.243 | 0.241 |

As shown in Table 4, uncured insulation of this invention is pliable to be practically applied by inflatable mandrel technique. In this method, the insulation is overlapped on a rubber air bag. The bag is then inflated in the rocket motor case and the insulation is therefore tightly adhered onto it. After the bag is vented and moved out, the insulation is heated to cure. Furthermore, the uncured insulations are tough enough to be suitable for various processing methods, such as hand lay up process, inflatable mandrel technique, strip-winding method and wrapping on propellant grain method, in practical application.

Ablative Resistance

The uncured insulations prepared from Example 1 through Example 5 are cured in a steel mold under 130° C. and 30 kgf/cm² for 2 hours into 6 mm think insulation rubber plates. Then ASTM E 285 standard test method is followed for the ablation resistance test of these samples. In this method, flame formed by a gas mixture of oxygen (2.4 ft³/min) and acetylene (1.7 ft³/min) was used as a heat source for the touch blaze that vertically belches the samples. Time to burn through the samples was recorded to measure the ablation resistance thereof as listed in Table 5.

TABLE 5
Ablation resistance properties of insulation specimens

| | Examples | | | | |
|---|---|---|---|---|---|
| | 1 | 2 | 3 | 4 | 5 |
| decomposition rate (sec/mm) | 9.02 | 8.48 | 7.85 | 9.36 | 10.09 |
| erosion rate (mm/sec) | 0.111 | 0.138 | 0.14 | 0.132 | 0.099 |

As shown in Table 5, insulations of the present invention exhibit superior ablation resistance along with their low density property. It carbonizes to form hard char that provides the good ablative resistance properties of these insulations. The insulation of the present invention is well capable to be used in rocket motor of tactical missiles.

Smoke Density

Cured insulation samples of Example 1, 4 and 5 from Table 3 were chosen to conduct smoke density test. Herein, ASTM E 662 standard test method is followed and a NBS smoke chamber introduced by the National Bureau of Standard (NBS) of the U.S. is applied to measure smoke density of the burning gas produced during combustion of the tested samples. The results are indicated in Table 6.

TABLE 6
Smoke density test results

| | Examples | | |
|---|---|---|---|
| Ingredients (phr) | 1 | 4 | 5 |
| halogen fire retardant | 0 | 0 | 35 |
| antimony oxide (Sb₂O₃) | 0 | 0 | 10 |
| aluminum hydroxide (Al(OH)₃) | 10 | 20 | 20 |
| polyaramide fiber | 12.5 | 12.5 | 12.5 |
| the smoke density (Dm) * | 169 | 176 | 219 |

* flaming test, no unit.

The test results in Table 6 shows that when halogen fire retardants are excluded in the insulation formulation, smoke density is evidently lowered. Furthermore, in these formulations that do not employ halogen fire retardants, increasing the amount of the aluminum hydroxide doesn't give much help in reducing smoke density.

Smoke Toxicity

Cured insulation samples of Example 1, 4 and 5 from Table 3 were chosen to conduct smoke toxicity test. Herein, ASTM E 1687 standard test method is followed and a Combustion Toxicity Test Apparatus introduced by the National Institute of Building Sciences (NIBS) of the U.S. is used to measure toxicity of the smoke produced from combustion of the insulation.

TABLE 7
The results for the smoke toxicity test

| | Examples | | |
|---|---|---|---|
| Ingredients (phr) | 1 | 4 | 5 |
| halogen fire retardant | 0 | 0 | 35 |
| antimony oxide (Sb₂O₃) | 0 | 0 | 10 |
| aluminum hydroxide (Al(OH)₃) | 10 | 20 | 20 |
| polyaramide fiber | 12.5 | 12.5 | 12.5 |
| smoke toxicity LD₅₀ (gm/m³) | 39.30 | 41.54 | 23.87 |

The results show that when aluminum hydroxide (Al(OH)₃) is used to replace the halogen fire retardant in the insulation formulation, a much better smoke toxicity suppression effect results.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A composition of elastomeric insulation, suitable for a solid propellant rocket motors, whose density is lower than 1.0 gm/cm³, the composition comprising:
(a) 50 parts per hundred parts of rubber by weight (phr) to 100 phr, based on 100 parts by weight of a solid ethylene propylene diene monomer (EPDM) rubber and a liquid EPDM rubber in total, of the EPDM rubber;
(b) 0 phr to 50 phr of the liquid EPDM rubber;
(c) 5 phr to 50 phr of a polyaramide fiber;
(d) 0.01 phr to 5 phr of a sulfur; and
(e) 0.01 phr to 5 phr of a curing accelerator.

2. The composition of claim 1, wherein the sulfur is colloidal sulfur.

3. The composition of claim 1, wherein a preferable amount of the sulfur is in the range from about 0.5 phr to about 2.5 phr.

4. The composition of claim 1, wherein the curing accelerator is at least one member selected from the group consisting of N-tert-butyl-2-benzothiazole sulfonamide and 4,4′-dithio dimorpholine and a mixture therefore.

5. The composition of claim 4, wherein an amount of the N-tert-butyl-2-benzothiazole sulfonamide is from about 0.01 phr to about 3 phr.

6. The composition of claim 5, wherein a preferable amount of the N-tert-butyl-2-benzothiazole sulfonamide is in the range from about 0.05 phr to about 2 phr.

7. The composition of claim 4, wherein an amount of the 4,4′-dithio dimorpholine is from about 0.01 phr to about 3 phr.

8. The composition of claim 7, wherein a preferable amount of the 4,4′-dithio dimorpholine is in the range from about 0.05 phr to about 2 phr.

9. The composition of claim 1, further comprising about 5 phr to 100 phr of inorganic fillers in the composition.

10. The composition of claim 9, wherein the inorganic fillers is at least one member selected from the group consisting of a silicon oxide, an aluminum hydroxide and a mixture thereof.

11. The composition of claim 9, further comprising about 1 phr to 10 phr of synthetic polyterpene resin used as a tackifier.

12. The composition of claim 11, wherein a preferable amount of the synthetic polyterpene resin is in the range from about 4 phr to about 8 phr.

13. The composition of claim 1, wherein the preferable amount of the solid EPDM rubber is from about 55 phr to about 80 phr.

14. The composition of claim 1, wherein a preferable amount of the liquid EPDM rubber is from about 20 phr to about 45 phr.

15. The composition of claim 1, wherein a fiber diameter of the polyaramide fiber is between 10 μm to 14 μm.

16. The composition of claim 15, wherein a ratio of a length to the fiber diameter of the polyaramide fiber is about 500.

17. The composition of claim 1, wherein a preferable type of the polyaramide fiber is a pulp form.

18. The composition of claim 17, wherein an amount of the pulp form of the polyaramide fiber is from about 5 phr to 20 phr.

19. The composition of claim 18, wherein a preferable amount of the pulp form of the polyaramide fiber is in the range from about 10 phr to about 15 phr.
